(19) United States
(12) Patent Application Publication
(10) Pub. No.: US 2002/0174033 A1
(43) Pub. Date: Nov. 21, 2002

(54) Verification method of replying work orders in a collaboration commerce system

(75) Inventor: Hui Chuan Lin, Taipei (TW)

Correspondence Address: MERCHANT & GOULD PC, P.O. BOX 2903, MINNEAPOLIS, MN, 55402-0903, US

(73) Assignee: Mitac International Corp., Hsinchu (TW)

(21) Appl. No.: 10/137,164

(22) Filed: May 2, 2002

(30) Foreign Application Priority Data
May 18, 2001 (TW) 90111910

(51) Int. Cl. G06F 17/60

(52) U.S. Cl. 705/26

(57) ABSTRACT

A verification method of replying work orders in a collaboration commerce system is disclosed to provide a verification procedure for order/order confirmation reply processes, OQA/IQC reply processes, return notification/classification/check inquiry processes, dead material reply processes, and bulletin information receiving processes.

### BACKGROUND OF THE INVENTION

1. Field of Invention

The invention relates to a verification method of replying work orders in a CC (Collaboration Commerce) system. In particular, it relates to a verification method that automatically replies work orders through a network in a CC system.

2. Related Art

E-commerce and Internet has become an undefeatable trend. According to the development in the E-commerce and the Internet, we can divide the E-commerce into three parts: business to consumer (B2C), Intranet, and business to business (B2B).

If an enterprise wants to have a successful E-commerce, its business model has to be re-evaluated to find out where the E-commerce applies. The first thing to consider is to provide consumers more extra value services via the operation efficiency increase (e.g. speeding up order processes, shortening material distributions, growing sales, lifting consumer satisfaction, lowering stocking, and having a successful marketing strategy). The enterprise should also help its business partner grow and move up, middle, and down stream vendors toward E-commerce together.

The development and prevalence of the Internet force us to consider two big subjects about Enterprise Resource Planning (ERP) and Supply Chain Management (SCM) that are not products of the Internet technology.

The ERP system is evolved from Manufacturing Resource Planning (MRPII). The biggest advantage of the ERP system is that it integrates various systems inside the enterprise, including sales, manufacturing, finance, accounting, human resources, and logistic supports. Therefore, the information inside the enterprise can be available and correct in real time.

Most of current E-commerce businesses only achieve data exchange and integration between up and down stream units. There is still much to do in order to simultaneously integrate and even optimize the data in all up, middle, and down stream resources. Even if all information are integrated and shared, it is still unlikely for a computer to find out an optimal solution due to all sorts of limitations and finite time.

Consequently, the SCM system is introduced to rapidly try approximately optimal solutions using the AI (Artificial Intelligence) techniques without performing conventional mathematical operations. Thus, not only does the user need to go through complicated mathematical formulas, an appropriate strategy can be found out in a relatively short period.

Due to shorter life cycles and lead times of products and faster information transmissions nowadays, the BTO (Build To Order) model has gradually moved toward the CTO (Configure To Order) model. It thus becomes the most urgent task to combine the supply chain inside the enterprise and the supply chain of the up, middle, and down stream vendors, forming an operation model integrating external collaboration.

Thus, for manufacturers a good procedure for immediately replying and verifying work orders to ensure the real-time validity of each message transmission is then a key issue to the success in CC.

### SUMMARY OF THE INVENTION

A primary object of the invention is to provide in a collaboration commerce system a verification procedure for order/order confirmation reply processes, OQA/IQC reply processes, return notification/classification/check inquiry processes, dead material reply processes, and bulletin information receiving processes.

The disclosed method can monitor the progress of the collaboration commerce, simplify processes of purchases, OQA, IQC and returns, and transmit real-time information.

### BRIEF DESCRIPTION OF THE DRAWINGS

The invention will become more fully understood from the detailed description given hereinbelow illustration only, and thus are not limitative of the present invention, and wherein:

FIG. 1 is a flowchart of account application on a web page;

FIG. 2 is a flowchart of the order/order confirmation reply process;

FIG. 3 is a flowchart of the vendor OQA/IQC reply process;

FIG. 4 is a flowchart of the return notification/classification/check inquiry process;

FIG. 5 is a flowchart of the dead material reply process; and

FIG. 6 is a flowchart of the bulletin information receiving process.

### DETAILED DESCRIPTION OF THE INVENTION

The invention proposes a verification method of replying work orders in a collaboration commerce system. It uses an auto mailing mechanism to reply work orders in real time and to complete a verification procedure through the link of a network. This method insures the real-time validity of each message transmission in the collaboration commerce. For example, a web page is designed to provide mechanisms of the order/order confirmation reply, the OQA/IQC reply, the return notice/classification/check inquiry, and the bulletin information reception.

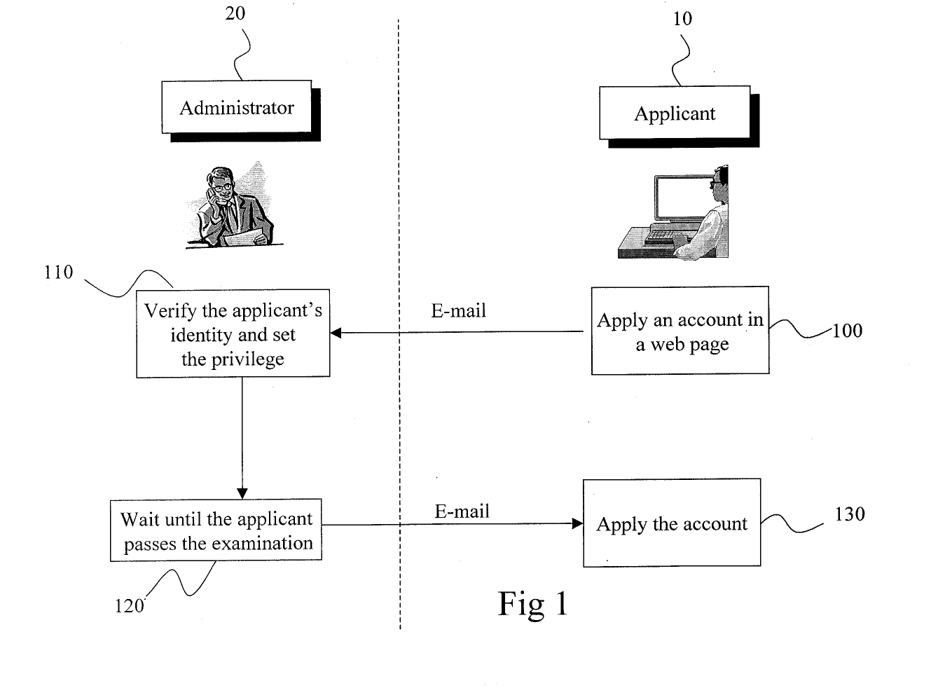

As shown in FIG. 1, the web page forms a common interface for transmitting work orders during the collaboration commerce o the network. Therefore, an applicant 10 (the same vendor can apply multiple accounts) has to apply an account at a CC (Collaboration-Commerce) hub web, filing an application to an administrator 20 of the web. After the applicant's identity verification and privilege settings (step 110), the account application (step 130) still does not start until the applicant passes the examination (step 120).

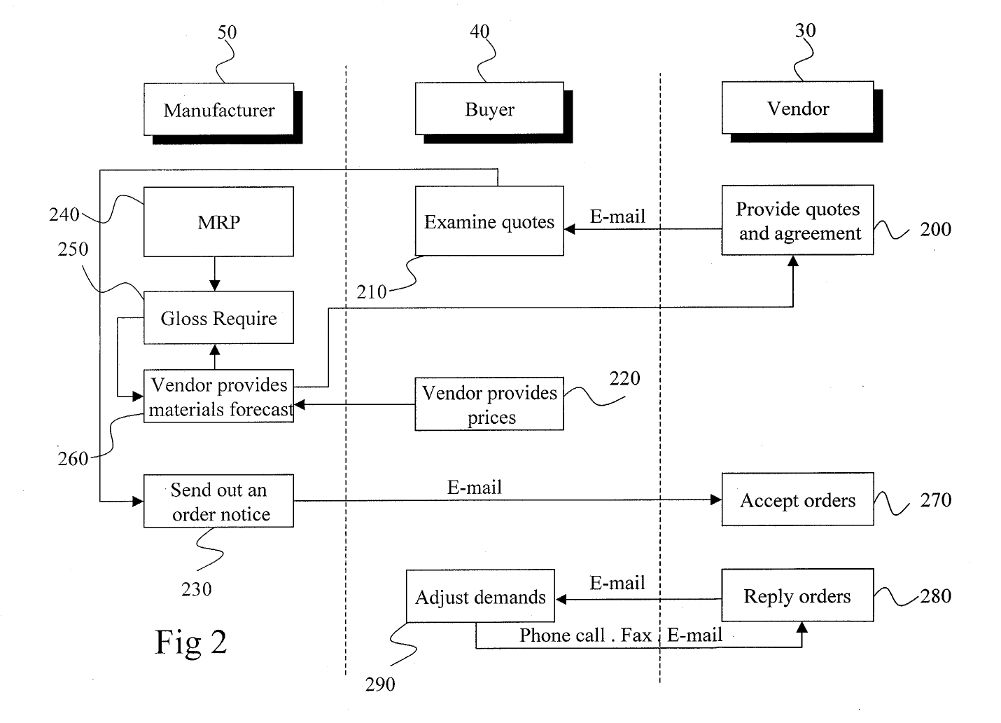

FIG. 2 includes the order transmission procedure among a vendor 30, a buyer 40, and a manufacturer 50. First, the vendor 30 provides quotes and an agreement (step 200). It allows the buyer 40 to perform quotes inquiry by E-mail (step 210). The buyer 40 checks the retail prices provided by the vendor 30 (step 220) and then sends out an order notice to the manufacturer 50 (step 230). According to the MRP (Manufacturing resource Planning) of the manufacturer 50, vendor materials forecast is performed (step 260) through gloss requiring (step 250). The forecast result is then returned to the vendor 30 for its reference with regard to quotes and agreements. The order is also sent to the vendor 30 via E-mail (step 270). In general, after the vendor 30 receives the order (step 270), it replies to the buyer 40 (step 280) for confirmation. If the buyer 40 wants to adjust the needs (step 290), he or she can notify the vendor in any communication method (phone calls, fax, E-mail, etc.) to make order adjustment. The adjusted order is then returned to the buyer for final confirmation.

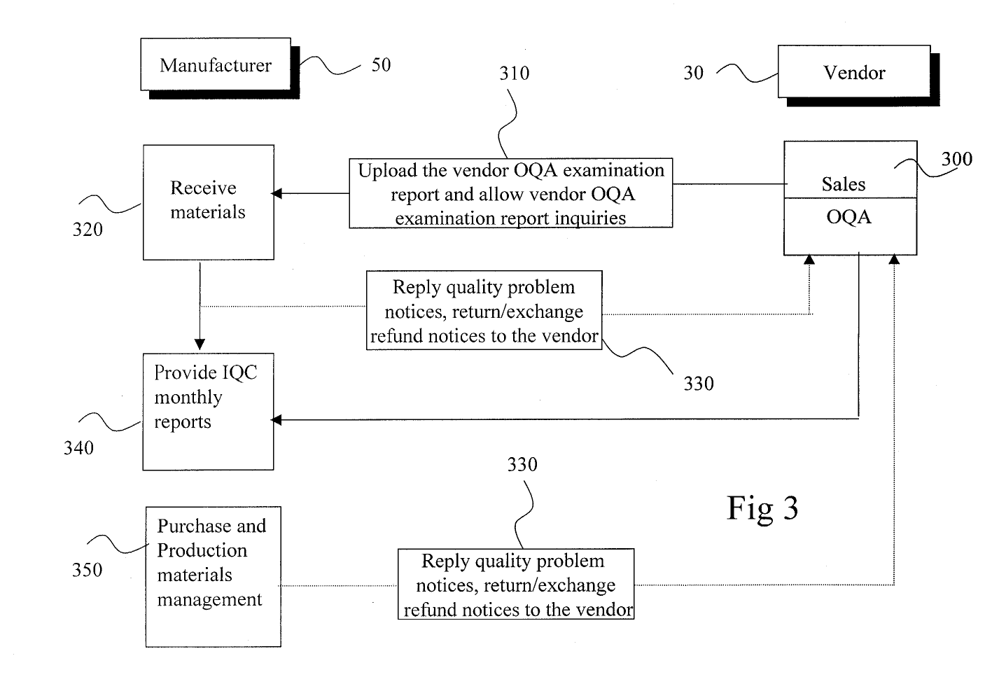

In FIG. 3, the OQA/IQC process between the vendor 30 and the manufacturer 50 plays an extremely important role of the monitoring mechanism. First, when the vendor 30 provides sales and OQA to the manufacturer 50 (step 300), the OQA examination report provided by the vendor 30 is uploaded to a CC hub web. The manufacturer 50 can perform vendor (IQC/OQA) examination report inquiries (step 310) at the same time of receiving materials (step 310). In the meantime, the manufacturer 50 can also check the quality of the received materials. Any quality problem notice and return/exchange refund notices is replied to the vendor (step 330). The vendor 30 further provides IQC monthly report (step 340) for the manufacturer to perform IQC. Moreover, during the process of purchases and production material management, information about any quality problem notice and return/exchange refund notices being sent to the vendor is also exchanged.

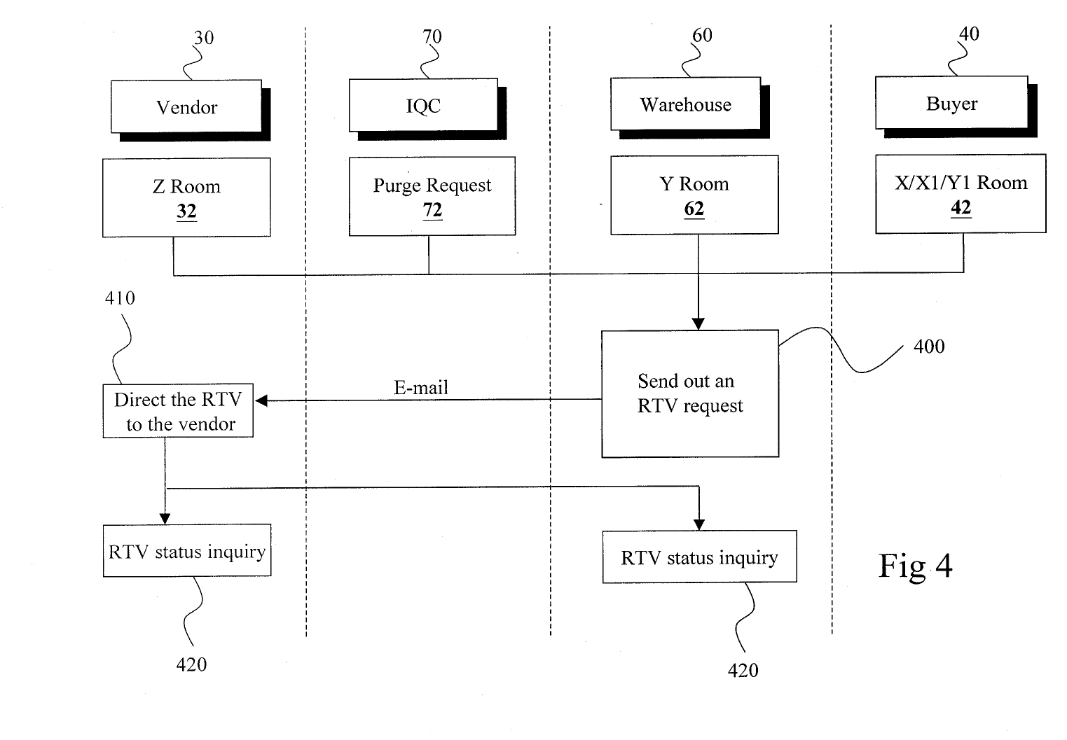

With reference to FIG. 4, to effectively manage rejected materials the invention provides several different stocking rooms.

Materials owned by the buyer:

X: Tax-deductible materials, which are accepted, not yet on the assembly lines and have been rejected;

X1: Tax-deductible materials, which are accepted, kitted to the assembly lines, and have been found problems on the assembly lines and thus rejected;

Y1: Non-tax-deductible materials, which are accepted, not yet on the assembly lines and have been rejected.

Materials owned by the vendor:

Y: Tax-deductible materials, which are stocked and rejected;

Z: Non-tax-deductible materials, which are rejected before being stocked.

For the X/X1/Y1 rooms 42 of the buyer 40, the Y room 62 of a warehouse 60, or the Z room 32 of the vendor 30, when a purge request 72 is made during the IQC 70 process the RTV request is made to the warehouse 60 (step 400). The reject/no return, return or classification request is also made at this point. The RTV is sent back to the vendor 30 via E-mail (step 410). A CC hub web provides RTV status inquiries for the vendor and the warehouse (step 420).

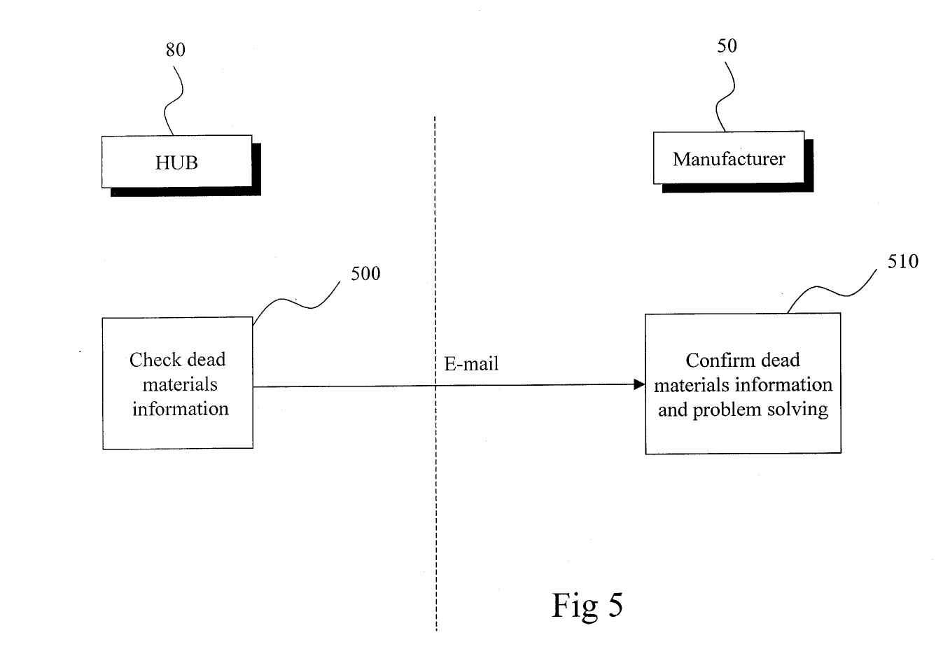

Referring to FIG. 5, a hub 80 sends dead materials information to the manufacturer 50 through E-mail (step 500) for confirming dead materials information and solving problems (step 510).

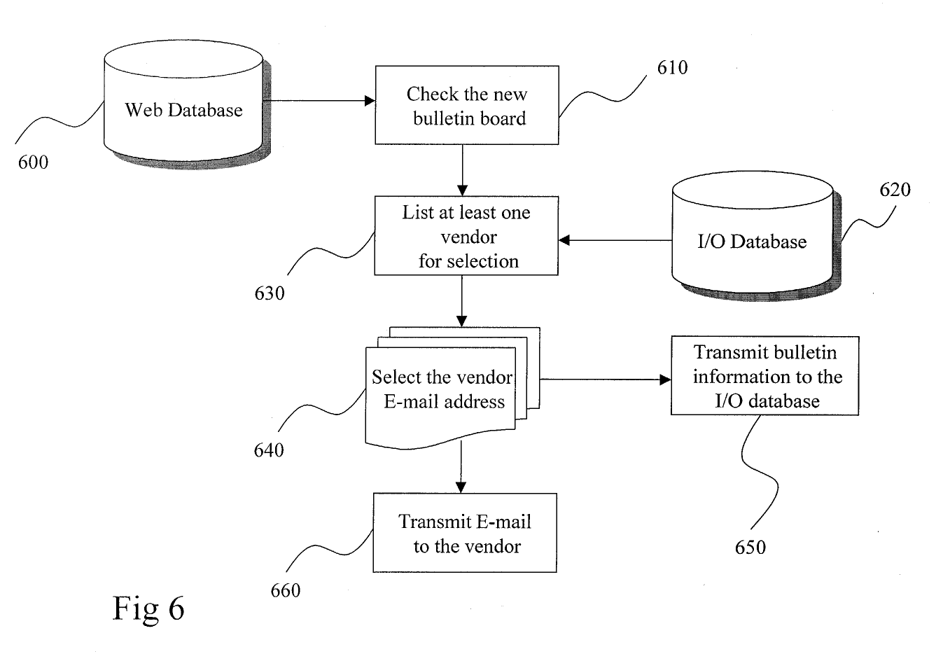

In FIG. 6, the message transmission procedure goes as follows: new bulletin information is checked in a web page database 600 (step 610). According to the new bulletin contents, at l e a s t one vendor from an I/O database 620 is listed for selection (step 630). Step 640 selects the vendor's E-mail address. The bulletin information is transmitted to the I/O database (step 650). A mailing mechanism then sends E-mail to the vendor according to the vendor's E-mail address (step 660).

According to the disclosed method, messages for any party (such as returns, dead materials, rejections) in the business can be transmitted through a message mailing system. This method can completely control material stocking situations at any point in the company, forming the concept of “united warehouse” to avoid over-stocking in the main warehouse and to achieve the goal of transmitting real-time information. For example, suppose a manufacturer has a main warehouse at place A and a plurality of factories, each with small inventory, all over the world (at place B, place C, . . . ). If the factory at place B suddenly needs to replenish many material items due to received orders, the main warehouse (at place A) is forced to order materials from vendors. This emergent demands often increases the costs and requires extra financing. Stocks at other places may have become dead materials due to the expiry dates or specification changes in the products. Therefore, if an online inventory inquiry system can be established among the factories, the stocking conditions at different places can be monitored. Under the premise that material demand and supply at each factory are not affected, materials can be borrowed from one inventory to another, avoiding unnecessary purchases. This greatly helps more effectively using the enterprise's capital.

When a demanding unit inside the enterprise files a purchase request, the purchasing unit has to go through many administrative procedures, such as information collection, organization, examination, application, posting, and price-comparison. If people responsible for any of the procedures are not in so that nobody can make decisions, these operations will be delayed. This problem becomes more serious for larger companies. Using the disclosed method, all operations can be made into electronic forms. The communication processes are all electronic. Not only is the application unit then able to have close communications with relevant administrative units through systematic organization within a short time, the whole process is also monitored. Therefore, procedures of purchases, OQA, IQC, returns are simple and fast.

What is claimed is:

1. A verification method for replying work orders in a CC (Collaboration-Commerce) system to provide an order/order confirmation reply procedure, the method comprising the steps of:
a vendor providing a quote and an agreement to a buyer via E-mail;
the buyer examining the quote according to the provided quote and agreement;
the buyer sending an order notice to a manufacturer according to the quote from the vendor;
the manufacturer sending an order to the vendor according to the order notice via E-mail;
the vendor replying to the buyer via E-mail according to the order and allowing the buyer to adjust needs;
the buyer returning an adjusted order notice to the vendor via E-mail to confirm the order contents; and
the vendor returning to the buyer according to the adjusted order via E-mail.

2. The method of claim 1 further comprising the step of the vendor forecasting needed materials and sending the forecast result to the vendor for the vendor's reference in providing a quote and an agreement.

3. The method of claim 2, wherein the materials forecast by the vendor is performed through a GR (Gloss Require) according to an MRP (Manufacturing Resource Planning) of the manufacturer.

4. The method of claim 1, wherein the step of the buyer returning the adjusted order to the vendor is done by a method chosen from the group consisting phone calls, fax, and E-mail.

5. A verification method for replying work orders in a CC system to provide an OQA/IQC reply procedure, the method comprising the steps of:
a vendor providing a sales and an OQA to a manufacturer and uploading an OQA examination report of the vendor to a CC web site;
the manufacturer performing a vendor examination report inquiry at the same time of receiving materials from the vendor; and
the manufacturer sending a quality problem notice and a return/exchange refund notice to the vendor according to the inquiry result.

6. The method of claim 5 further comprising the step of the vendor providing a IQC monthly report to the manufacturer for the manufacturer to do IQC.

7. The method of claim 5 further comprising the step of returning the quality problem notice and the return/exchange refund notice to the vendor during the process of the manufacturer's purchase and production materials management.

8. A verification method for replying work orders in a CC system to provide a return notice/classification/check inquiry procedure, the method comprising the steps of:
providing an RTV request to a warehouse when a purge request is proposed during an IQC process;
the warehouse replying the RTV request to a vendor via E-mail; and
allowing the vendor to check the RTV request status in the warehouse through a CC hub web.

9. The method of claim 8, wherein the RTV request is selected from the grouping consisting of rejection/no return, return, and classification.

10. The method of claim 8 further comprising the step of a hub checking dead materials information and sending the dead materials information to the manufacturer via E-mail for confirmation and problem solving.

11. A verification method for replying work orders in a CC system to provide a bulletin information receiving procedure, the method comprising the steps of:
checking new bulletin information in a web database;
listing at least one vendor from an I/O database according to the new bulletin information for selection;
selecting the E-mail address of the vendor and sending the new bulletin information to the I/O database; and
sending E-mail to the vendor according to the vendor's E-mail address using a mailing mechanism.
